(19) United States
(12) Patent Application Publication
(10) Pub. No.: US 2017/0215626 A1
(43) Pub. Date: Aug. 3, 2017

(54) AUTOMATIC BEVERAGE BREWING DEVICE

(71) Applicant: Anantha Pradeep, Piedmont, CA (US)

(72) Inventor: Anantha Pradeep, Piedmont, CA (US)

(21) Appl. No.: 15/008,709

(22) Filed: Jan. 28, 2016

(51) Int. Cl. A47J 31/18; A23F 3/18

(52) U.S. Cl. CPC A47J 31/18; A23F 3/18

(57) ABSTRACT

In general, certain embodiments of the present disclosure provide devices and methods for brewing beverages. According to various embodiments, the device comprises a pipe structure coupled to a chamber. In some embodiments, the chamber may be configured to house a brewing agent. The device further comprises a pump coupled to the pipe structure. In some embodiments, the pump may be configured to cause water in a container to be pumped through an intake aperture in the pipe structure. The device further comprises a heating element coupled to the pipe structure. In some embodiments, the heating element may cause the water to be heated. In some embodiments, the water in the pipe structure may be directed through the chamber in order to steep the brewing agent in the water.

### TECHNICAL FIELD

The present disclosure relates generally to beverage and food preparation, and more specifically to the automatic brewing of beverages.

### BACKGROUND

Tea is an aromatic beverage commonly prepared by pouring hot or boiling water over cured leaves of the Camellia sinensis, an evergreen shrub native to Asia. After water, it is the most widely consumed drink in the world. There are many different types of tea, such as white tea, yellow tea, green tea, oolong, pu-erh tea and black tea. Such tea is harvested from one of two major varieties of Camellia sinensis. Additionally herbal teas include infusions of fruit or herbs made without the tea plant, such as steeps of rosehip, chamomile, or rooibos. These are also known as tisanes or herbal infusions to distinguish them from “tea” as it is commonly construed.

The traditional technique of preparing tea is to place loose tea leaves directly (or in a tea infuser) into a tea pot or teacup, pour freshly boiled water over the leaves, and allow the infused liquid to steep (or “brew”). After a few minutes, the infuser is removed, or the tea is poured through a strainer while serving. There may be a specific temperature and steeping time for each variety of tea or herbal tea that provides the optimal flavor or strength. Delicate leaves steeped at too high of a temperature will burn and leave a bitter flavor in the cup. Similarly, there may be various brewing times and temperatures desired and/or required for various types of beverages in addition to tea, such as coffee and coffee beverages. Thus, there is a need for automatically determining the optimal brewing time and/or temperature and a more convenient technique to brew a beverage for such time and/or temperature.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

In general, certain embodiments of the present disclosure provide devices and techniques for brewing beverages. In another embodiment, a system for brewing beverages is provided comprising one or more processors, memory, and a device for brewing beverages. According to various embodiments, the device comprises a pipe structure coupled to a chamber. In some embodiments, the chamber may be configured to house a brewing agent. The device further comprises a pump coupled to the pipe structure. In some embodiments, the pump may be configured to cause water in a container to be pumped through an intake aperture in the pipe structure. The device further comprises a heating element coupled to the pipe structure. In some embodiments, the heating element may cause the water to be heated. In some embodiments, the water in the pipe structure may be directed through the chamber in order to steep the brewing agent in the water.

In some embodiments, the water may be heated as it is pumped through the pipe structure. In other embodiments, the heating element may include an induction coil and the water may be heated by inducing an oscillating electric current in the container. In some embodiments, the device may further comprise a thermostat that measures the temperature of the water in the container, or pumped through the pipe structure, and causes the device to adjust the heating element or a timing element to reach or maintain a predetermined temperature. In some embodiments, the water may not access the chamber before the water is heated to a predetermined temperature. In other embodiments, the pump or the heating element may operate for a predetermined period of time. In further embodiments, the device may further comprise a concentration detector that measures the concentration of the brewing agent, or a substance included in the brewing agent, in the water. In some embodiments, the water may not access the chamber once a desired concentration of the brewing agent, or substance in the brewing agent, has been detected in the water.

In other embodiments, the device my further comprise a user interface to receive user input. In various embodiments, the user input may include one or more of the following: a brewing agent type, an amount of water, a volume amount, an amount of brewing agent, a desired concentration of the brewing agent, or substance included in the brewing agent, a predetermined temperature, and a predetermined period of time. In further embodiments, the device may be configured to receive user input from the user interface, receive information from a source based on the user input, and automatically determine one or more of the following: a predetermined temperature, and a predetermined time.

In yet a further embodiment, a technique for brewing beverages is provided. In various embodiments, the technique comprises pumping water from a container through an intake aperture of a pipe structure. In some embodiments, the pumping may be caused by a pump coupled to the pipe structure. In some embodiments, the pipe structure may be coupled to a chamber that is configured to house a brewing agent. The technique further comprises heating the water from the container by a heating element. The technique further comprises directing the water in the pipe structure through the chamber in order to steep the brewing agent in the water.

### BRIEF DESCRIPTION OF THE DRAWINGS

The disclosure may best be understood by reference to the following description taken in conjunction with the accompanying drawings, which illustrate particular embodiments of the present disclosure.

FIG. 1 illustrates a general overview of an example system for implementing various devices and techniques of the present disclosure, in accordance with one or more embodiments.

FIG. 2 illustrates an example of a system for automatically brewing a beverage, in accordance with one or more embodiments.

FIG. 3A illustrates an example of a device for automatically brewing a beverage, in accordance with one or more embodiments.

FIG. 3B illustrates an example of a device for automatically brewing a beverage with an open brew chamber, in accordance with one or more embodiments.

FIG. 3C illustrates an example of a device for automatically brewing a beverage with an alternate brew chamber used in a container, in accordance with one or more embodiments.

FIGS. 4A and 4B illustrate a technique for automatically brewing a beverage, in accordance with one or more embodiments.

FIG. 5 is a block diagram illustrating an example of a system capable of implementing various processes described in the present disclosure.

### DETAILED DESCRIPTION OF PARTICULAR EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, the techniques of the present disclosure will be described in the context of particular tea types. However, it should be noted that the techniques of the present disclosure apply to various other tea types and beverages. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

According to various embodiments, devices and techniques for automatically brewing tea are provided. In some embodiments, the brewing device may comprise a thin cylindrical body sized to fit in a typical beverage container such as a tea cup or coffee mug. In some embodiments, various components and/or elements described below may be housed within the body of the brewing device. In some embodiments the device may comprise a pump that pumps water from the beverage container into a pipe structure through an intake aperture that is submerged below the surface of the water. In some embodiments, the water is cycled through the brewing device as it is pumped through the pipe structure and out an exit aperture into the container.

In some embodiments, the brewing device may comprise a brew chamber configured to house a brewing agent. In some embodiments, the brew chamber may be a compartment within the body of the brewing device. In other embodiments, the brew chamber may be a separate container that that may be attached and detached to the brewing device. In various embodiments, a brewing agent may include various types of tea leaves or ground coffee beans. In some embodiments, the brewing agent may be contained in a tea bag or other porous container. In some embodiments, the water is pumped through the pipe structure and directly into the brew chamber, allowing water to steep the brewing agent as it is being heated. In other embodiments, the brew chamber and the pipe structure may be separated by a water tight divider that prevents water from accessing the brew chamber from the pipe structure.

In some embodiments, the brewing device further may comprise a heating element. In some embodiments, the heating element may heat the water as it is pumped through the pipe structure. In other embodiments, the heating element may include an induction coil that causes an oscillating electric current in the container which heats the water. In some embodiments, the brewing device may further comprise a thermostat which measures the temperature of the water. Once a predetermined temperature has been detected, the water tight divider may be shifted to allow the heated water to enter the brew chamber to steep the brewing agent. In other embodiments, the thermostat may cause the heating element to be adjusted to reach or maintain a predetermined temperature. In some embodiments, the brewing device may further comprise a timing element that may cause the water tight divider to open and close based on a predetermined time. In some embodiments, the timing element may also determine when the pump and the heating element are operational. In further embodiments, the thermostat and timing element may work in conjunction to cause the operation of the pump, heating element, and or divider to be adjusted.

In some embodiments, the brewing device may further comprise a concentration detector that may measure the concentration of the brewing agent in the water, or a substance in the brewing agent in the water. For example, the concentration detector may measure the concentration of caffeine within the water. In some embodiments, the concentration detector may cause the operation of the pump, heating element, and/or divider to be adjusted based on its measurements. In some embodiments, the concentration detector may measure the concentration of the water in the container or as it is pumped through the pipe structure.

In various embodiments, the brewing device may also comprise a programmable system controller that may control the operation of various elements and/or components of the brewing device. In various embodiments, the programmable system controller may include one or more processors, memory, and one or more programs stored in the memory. In some embodiments, the programmable system controller may be configured to receive user input from a user interface. In some embodiments, the programmable system controller may control the operation of various elements and/or components based on the user input. For example, the user input may include one or more of the following: a brewing agent type, an amount of water, a volume amount, an amount of brewing agent, a desired concentration of the brewing agent or substance included in the brewing agent, a predetermined temperature, and a predetermined period of time. For example, the programmable system controller may use such user input to begin the heating element and set the thermostat to detect an input predetermined temperature and the timing element to count a predetermined time. Once a predetermined temperature is detected, the thermostat may signal the divider to be opened to allow water to enter the brew chamber to begin steeping the brewing agent. The thermometer may also signal the timing element to begin timing. The thermometer may also signal to adjust the heating element to maintain the predetermined temperature. Once the timing element has counted to a predetermined time, the timing element may then signal for the divider to be closed to prevent water from accessing the brew chamber. The timing element, may also signal to shut off the pump and/or the heating element.

In further embodiments, the programmable system controller may be configured to receive information from a source based on the received user input. In various embodiments, the source may be local storage or one or more global databases accessed through a global network, such as the Internet. For example, based on an input brewing agent type, the programmable system controller may receive from local storage an optimal suggested time and water temperature to brew such brewing agent. As another example, based on an input brewing agent type, the programmable system controller may receive one or more optimal suggested times from various global databases and water temperatures to brew such brewing agent. Such information may be ranked based on keyword, prior usage, ranking by third parties, etc. In some embodiments, the programmable system controller may determine a time and water temperature for brewing such brewing agent based on the received information. In another embodiment, the programmable system controller may determine a time and water temperature by presenting a user with the received information and prompting the user to select a desired time and water temperature to brew the brewing agent. In such embodiments, the programmable system controller may use the received and/or determined information to control various elements and/or components of the brewing device. In some embodiments, the brewing device accesses the global network via wireless technology, e.g. Bluetooth or WiFi technology.

### EXAMPLE EMBODIMENTS

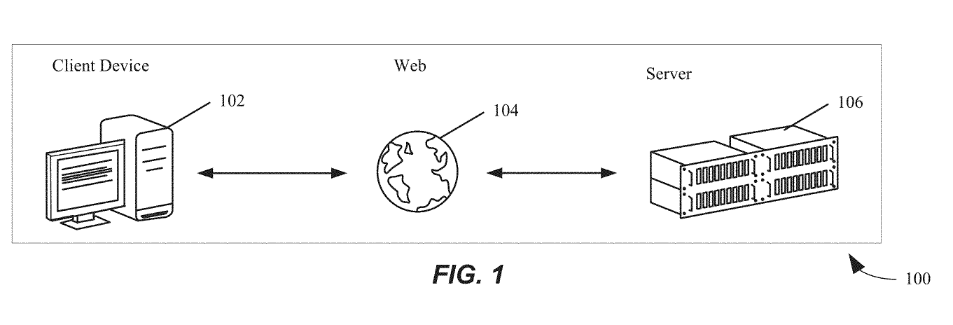

FIG. 1 illustrates a general overview of an example system 100 for implementing various techniques of the present disclosure, in accordance with one or more embodiments. In particular, FIG. 1 describes a user accessing web 104, such as the Internet or a global network, using a client device 102 configured with a web browser to interact with a server 106 containing modules required for fulfilling the user's request. In some embodiments, client device 102 can be a brewing device, as described in the present disclosure, or client device 102 can be a computer to which a brewing device wirelessly connects.

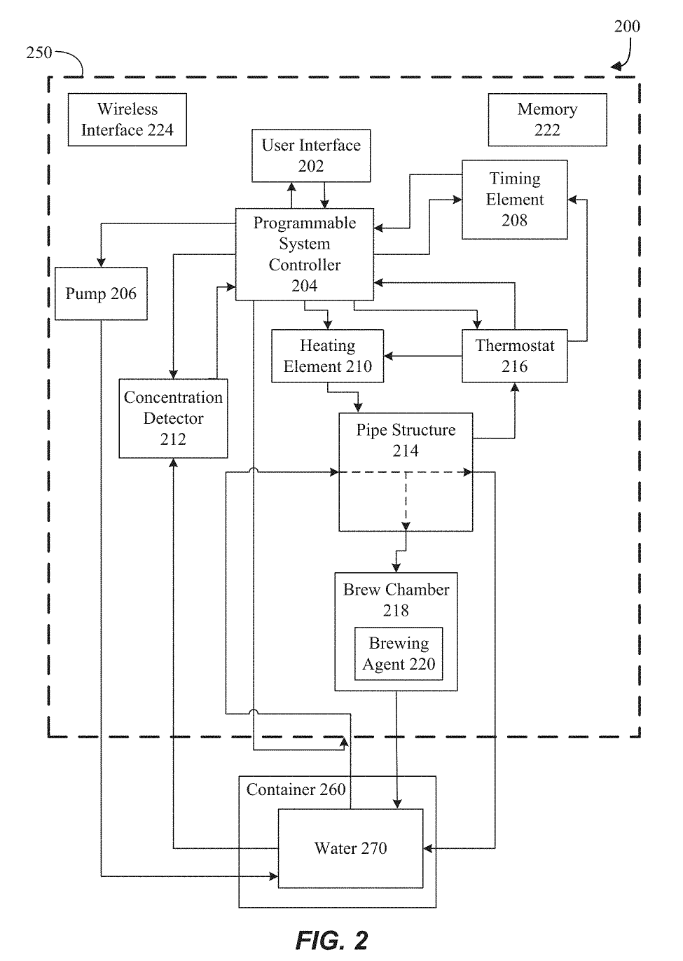

FIG. 2 illustrates an example of a system 200 for automatically brewing a beverage, in accordance with one or more embodiments. According to various embodiments, system 200 includes user a brewing device 250 and container 260 with water 270. In some embodiments container 260 may be a cup or other vessel capable of containing water 270 or other liquid. In various embodiments, brewing device 250 may be client device 102 as shown in FIG. 1. In some embodiments, brewing device 250 includes interface 202, programmable system controller 204, pump 206, timing element 208, heating element 210, concentration detector 212, pipe structure 214, thermostat 216, brew chamber 218, brewing agent 220, memory 222, and wireless interface 224.

In some embodiments, a brewing agent 220 is loaded into and/or unloaded from brew chamber 218. In various embodiments, brewing agent 220 may be any one of or a combination of various types of tea leaves, including, but not limited to, white tea, green tea, oolong tea, black tea, mate tea, or rooibos tea. In other embodiments, brewing agent 220 may be any one of various herbs or spices including, but not limited to, nettle leaf, chamomile, ginger, peppermint, lavender, etc. In some embodiments, brewing agent 220 may be contained in a conventional tea bag or any other porous container. In other embodiments, brewing agent 220 may be ground coffee beans or any other substance used for brewing beverages. In some embodiments, a brewing agent 220 comprising ground coffee beans or other substances may also be contained in a porous bag or sack. In some embodiments, brew chamber 218 may comprise a filter or grate that may prevent brewing agent 220 from escaping brew chamber 218 while allowing water 270 to pass through.

In some embodiments, a user may enter inputs at user interface 202. In various embodiments, inputs may include one or more of the following: a brewing agent type, an amount of water 270, a volume amount, an amount of brewing agent, a desired concentration of the brewing agent or substance included in the brewing agent, a predetermined brewing temperature, and a predetermined brewing time. In other embodiments, the input may include other desired attributes. For example, brewing agent types may include an identification of any one of various types of teas, such as white tea, green tea, oolong tea, black tea, mate tea, rooibos tea, or herbal tea. In some embodiments, brewing agent type may identify the type of tea more specifically. For example, varieties of black tea may be identified, including Assam, Nepal, Darjeeling, Nilgiri, Turkish, Keemun, and Ceylon teas. In other embodiments, brewing agent type may include whether the tea is loose leaf or contained in tea bag. In other embodiments, the particular brand of tea or tea bag may be identified in the input corresponding to brewing agent type. In other embodiments, the input may identify any type of coffee beans and/or brand of coffee. In some embodiments, input corresponding to a desired concentration of the brewing agent, or substance in the brewing agent, may include a selection of strength of the tea, such as light, medium, or dark. In other embodiments, an input corresponding to desired concentration of a substance in the brewing agent may include a concentration of caffeine in the brewed beverage, such as weak, medium, or strong.

In some embodiments, the user interface 202 includes buttons, a keypad, a mouse, or a touchscreen for receiving user input. In some embodiments, user interface 202 interacts with wireless interface 224 in order to receive the user input wirelessly via an electronic user device. For example, user interface 202 may receive user input from a user's personal computer, or the user's personal cell phone or other portable handheld device.

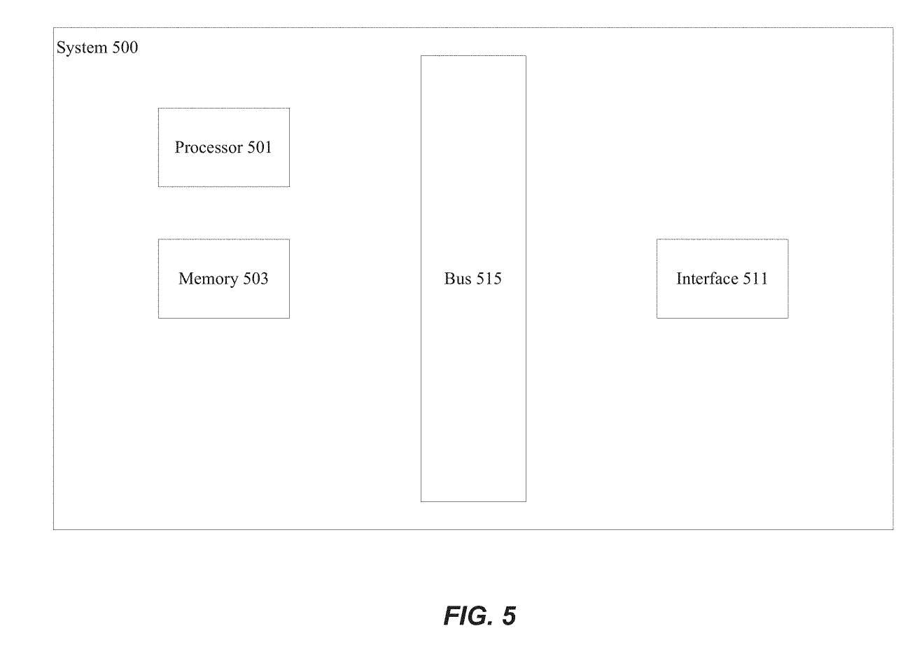

In some embodiments, user interface 202 communicates such inputs to programmable system controller 204. In particular embodiments, programmable system controller 204 may include a processor, memory, and/or an interface for communicating with various device elements and/or components. In some embodiments, programmable system controller 204 may receive information from a source based on the user input received. In some embodiments, the source may be local storage, such as memory 222. In some embodiments, memory 222 may store data associated with suggested brewing temperatures and suggested brewing times for particular types of brewing agents. In other embodiments, memory 222 may further store data and program instructions for controlling programmable system controller 204 for receiving the user input, receiving information from various sources, determining a predetermined temperature and/or period of time for brewing, and/or controlling various device elements and/or components. In some embodiments, memory 222 may be memory 503, as further described in FIG. 5. In other embodiments, the source may be one or more global databases, such as server 106, accessed through a global network, such as the Internet or web 104. In some embodiments, one or more global networks may be accessed by wireless interface 224, which may be configured to send and receive data packets or data segments over a global network, such as the Internet or web 104. In some embodiments, data received through wireless interface 224 may be stored in memory 222 for processing by programmable system controller 204. In some embodiments, wireless interface 224 may be interface 511, as further described in FIG. 5.

In various embodiments, information received from a source may include recommended temperatures to steep various brewing agents. In other embodiments, information received may include recommended times to steep various brewing agents. For example, input received may include a brewing agent type of green tea within a tea bag. Based on this input, programmable system controller 204 may receive information including a suggested temperature of 167°-176° F. and a suggested brewing time of 1-2 minutes. The programmable system controller 204 may then determine a temperature of the water and/or a time for the tea to be steeped by the heated water. In the previous example, the system controller 204 may determine the temperature based on the received information, such as by averaging one or more suggested temperatures received for green tea. Similarly, the system controller 204 may determine the brewing time by averaging the suggested brewing times received for green tea. Alternatively, the programmable system controller 204 may determine the temperature and/or brew time based on the received user input. For example, the received input may further include a selection of dark for the desired concentration and/or strength. Based on this input, the system controller 204 may automatically determine to steep the green tea for a longer period of time within the ranges received from the source. As another example, user input of brewing agent type may be more specific and identify a brand and type of the tea. Based on this input, programmable system controller 204 may receive information corresponding to the specific temperature and time to steep such brand of tea.

In various embodiments, programmable system controller 204 may control the operation of the various elements and/or components of brewing device 250, including pump 206, timing element 208, heating element 210, concentration detector 212, and thermostat 216. In some embodiments, programmable system controller 204 may control various elements and/or components of brewing device 250 based on the received user input. In embodiments, programmable system controller 204 may control operation of the various elements and/or components of brewing device 250 based on information received from one or more sources. In further embodiments, programmable system controller 204 may control operation of the various elements and/or components based on determinations made from the received information. In various embodiments, programmable system controller 204 may include memory and one or more processors. An example of a programmable system controller 204 is further described in FIG. 5.

In some embodiments, pump 206 causes water 270 to be pumped through pipe structure 214. In some embodiments, programmable system controller 204 may initiate and/or terminate pump 206. In some embodiments, water 270 may enter pipe structure 214 through an intake aperture and may exit through an exit aperture back into container 260. In some embodiments, pipe structure 214 may be coupled to brew chamber 218. In some embodiments water 270 may be pumped through pipe structure 214 and directly into brew chamber 218. In other embodiments, pipe structure 214 and brew chamber 218 may be separated by a water tight divider such that water 270 pumped through pipe structure 214 may not enter brew chamber 218 until such divider is moved and/or shifted open.

In some embodiments, brewing device 250 may include timing element 208. As previously described, in some embodiments, input received from user interface 202 may include a predetermined time for brewing. Furthermore, a predetermined time may be received by the programmable system controller 204 from one or more sources, or determined by the programmable system controller 204. For example, information received from one or more sources may include one or more suggested brewing times. In some embodiments, programmable system controller 204 may update and/or set timing element 208 with the predetermined time for brewing. In some embodiments, timing element 208 may signal to the programmable system controller 204 when to begin and/or end operation of the pump 206 and/or heating element 210. In some embodiments timing element 208 may signal to the pump 206 and/or heating element 210 directly. In some embodiments, timing element 208 may cause brewing device 250 to close the divider after a predetermined time.

In some embodiments, brewing device 250 may include heating element 210. In certain embodiments, heating element 210 causes water 270 in container 260 to be heated. In some embodiments, heating element 210 causes water 270 to be heated as it is pumped through pipe structure 214. For example, heating element 210 may heat a portion of pipe structure 214 such that the water 270 is heated as it is pumped through pipe structure 214. In other embodiments, heating element 210 may heat water 270 directly in container 260. For example, heating element 210 may heat a portion of pipe structure 214 in direct contact with water 270 in container 260, thereby heating the water directly in the container. In another example, heating element 210 may include an induction coil of copper or other suitable material. The induction coil may be used to create an oscillating magnetic field which induces an oscillating electric current in a container 260 made of iron or other magnet attracting material. The resistance of container 260 to the induced current causes it to heat up and heat water 270. In some embodiments, container 260 may include a limited area of material that may be heated by induction, such as the bottom surface, while the sides of container 260 may comprise an insulating material to prevent conduction of heat to the rest of container 260.

In some embodiments, brewing device 250 may include thermostat 216. In some embodiments, thermostat 216 may measure the temperature of the water 270. In some embodiments, thermostat 216 may measure the temperature of water 270 in container 260. In other embodiments, thermostat 216 may measure the temperature of water 270 as water 270 is pumped through pipe structure 214. As previously described, in some embodiments, input received from user interface 202 may include a predetermined temperature of the water for brewing. Furthermore, a predetermined temperature of water may be received by the programmable system controller 204 from one or more sources, or determined by the programmable system controller 204. For example, information received from one or more sources may include one or more suggested water temperatures for brewing. In some embodiments, programmable system controller 204 may update and/or set thermostat 216 with the predetermined temperature for brewing.

In some embodiments, thermostat 216 may cause the brewing device 250 to adjust the heating element 210 and/or timing element 208 to reach or maintain a predetermined temperature. In some embodiments, heating element 210 may be adjusted by modification in energy output. For example, heating element 210 may be adjusted by shutting heating element 210 off as soon as the temperature of the water rises a predetermined increment above the predetermined temperature, and turning heating element 210 on as soon as the temperature drops a predetermined increment below the predetermined temperature. As shown in FIG. 2, thermostat 216 may directly control the operation of heating element 210 and/or timing element 208. However, in other embodiments, thermostat 216 may alternatively, or additionally, signal to the programmable system controller 204 when to begin and/or stop operation of heating element 210 and/or timing element 208. In some embodiments, thermostat 216 may cause brewing device 250 to open the divider separating pipe structure 214 and brew chamber 218 when the water reaches the predetermined temperature.

As an example, user input received from user interface may include 2 minutes for a predetermined time and 175° F. for a predetermined temperature of water for brewing brew agent 220. Programmable system controller 204 may begin operation of heating element 210 to heat water 270. Programmable system controller 204 may update thermostat 216 with the predetermined brew temperature and timing element 208 with the predetermined time. Once thermostat 216 determines that water 260 has reached the predetermined temperature of 175° F., it may cause the programmable system controller 204 to cause timing element 208 to begin timing, and to move the divider between pipe structure 214 and brew chamber 218 to allow heater water 260 to flow through brew chamber 218 to steep the brewing agent 220. Thermostat 216 may also adjust heating element 210 to maintain the temperature of water 260 at 175° F. Once timing element 208 has counted 2 minutes, the programmable system controller 204 may stop pump 206 and heating element 210, and reset the divider to close off brew chamber 218 from pipe structure 214.

In some embodiments, brewing device 250 may further include concentration detector 212 to measure the concentration of the brewing agent, or a substance in the brewing agent, in the water. For example concentration detector may be configured to measure the concentration of caffeine in the water. In some embodiments, concentration detector 212 may utilize a sensitive electrochemical technique, based on a DNA-functionalized single walled carbon nanotube (DNA-SWCNT) and Nafion composite film modified glassy carbon electrode to determine concentration of caffeine in tea and other beverages. In some embodiments, concentration detector 212 may be set to detect a predetermined concentration based on user input from user interface 202. For example the user input may include a selection from one of the following: light, medium, dark, weak, or strong. Each user input may correspond to a particular concentration of caffeine. In some embodiments, concentration detector 212 may cause the divider between brew chamber 218 and pipe structure 214 to close once a predetermined concentration has been detected in the water. In other embodiments, concentration detector 212 may also cause pump 206 and/or heating element 210 to deactivate once a predetermined concentration has been detected in the water. In some embodiments, concentration detector 212 may signal to the programmable system controller 204 or directly to the components in brewing device 250.

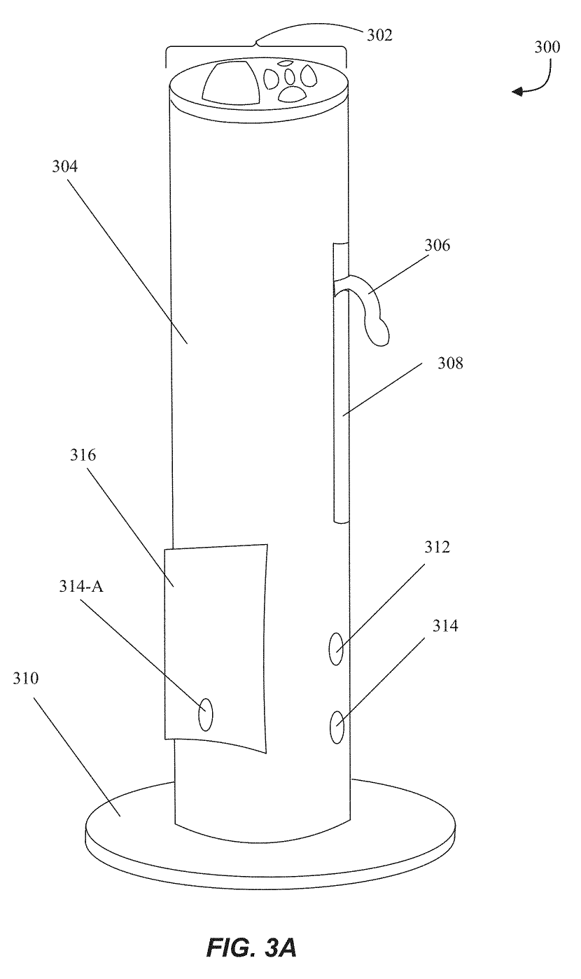

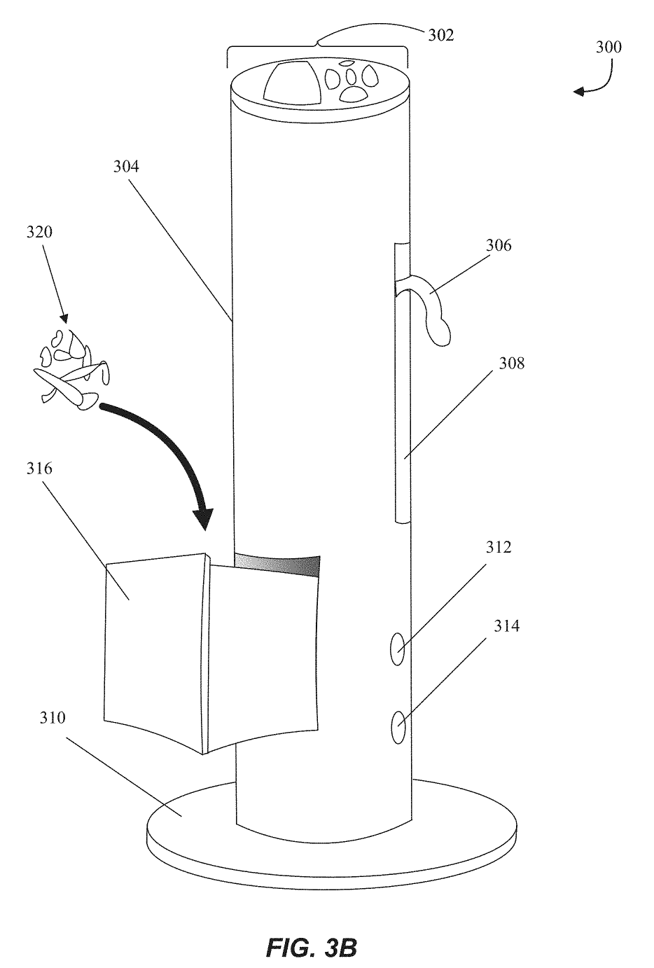

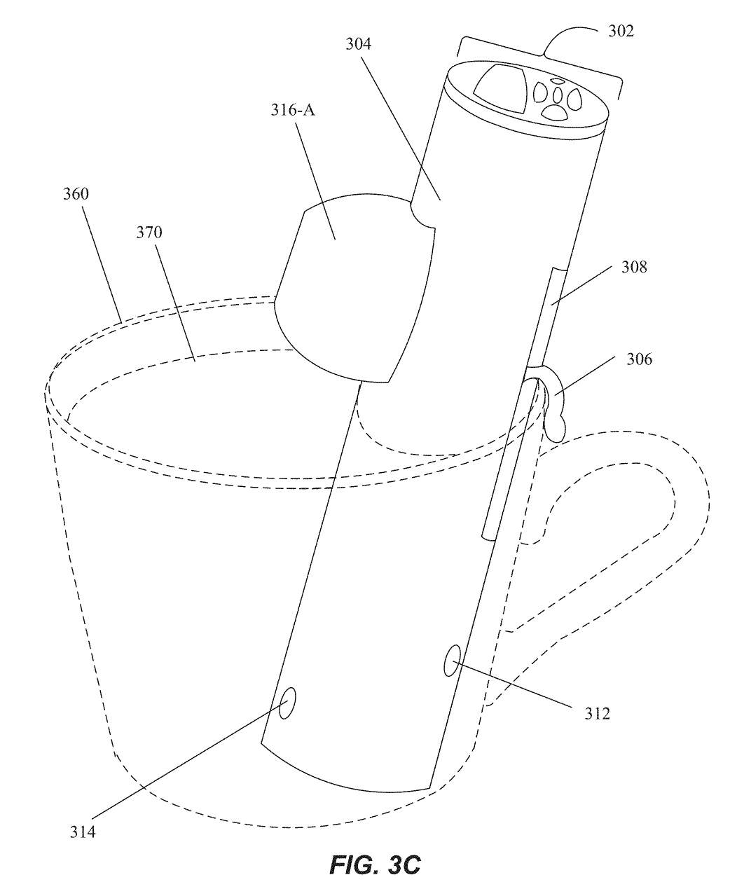

FIG. 3A and FIG. 3B illustrate examples of a device 300 for automatically brewing a beverage, in accordance with one or more embodiments. In some embodiments, device 300 may be brewing device 250 as described in FIG. 2. In various embodiments, device 300 includes user interface 302, body 304, hook 306, hook track 308, base 310, intake aperture 312, exit aperture 314, and brew chamber 316. FIG. 3B illustrates an example of a device for automatically brewing a beverage with an open brew chamber 316, in accordance with one or more embodiments. FIG. 3C depicts brewing device 300, including an alternate brew chamber 316-A, being used in conjunction with a container 360 containing water 370. In some embodiments, container 360 may be container 260 and water 370 may be water 270. In FIG. 3B, container 360 and water 370 have been depicted as transparent. In some embodiments, user interface 302 may be user interface 202, and may be used to enter the same or similar inputs as previously described in FIG. 2. In some embodiments, user interface 302 may include one or more buttons and/or display screens.

As depicted in FIGS. 3A, 3B, and 3C, the main body 304 of brewing device 300 may be a relatively thin cylindrical structure able to fit in a beverage container, such as container 360. In some embodiments, container 360 may be any typical beverage container, such as a tea cup or coffee mug. Many typical beverage containers include a circular base and shape, however, in other embodiments, the body 304 of brewing device 300 may be any shape suited to fit into a beverage container, such as container 360. In various embodiments, the body 304 may house the various elements and/or components of a brewing device 300, including, but not limited to programmable system controller 204, pump 206, timing element 208, heating element 210, concentration detector 212, pipe structure 214, thermostat 216, and brew chamber 218. In some embodiments, body 304 may form a water tight seal to prevent water or other liquids from contacting the internal components or elements, except as further described below.

In some embodiments brewing device 300 may further include a hook 306 to stabilize brewing device 300 within container 360, as shown in FIG. 3B. In some embodiments, hook 306 may slide along a hook track 308 to adjust to an appropriate height for a particular container 360. For example, as depicted in FIG. 3B, hook 306 has been adjusted on hook track 308 to contact the upper rim of container 360. In other embodiments, brewing device 300 may additionally, or alternatively, include a base 310. In some embodiments a wider base 310 may provide stability of brewing device 300. In some embodiments base 310 may be weighted to provide further stability.

Further depicted in FIGS. 3A, 3B, and 3C are intake aperture 312 and exit aperture 314 of a pipe structure, such as pipe structure 214. In various embodiments, as water is pumped from mug 360, the water enters the pipe structure through intake aperture 312 and exits back into container 360 from exit aperture 314. In some embodiments, intake aperture 312 and exit aperture 314 are submerged below the surface of water 370, as shown in FIG. 3B. However, in certain embodiments, exit aperture 314 may be located above the surface of water 370. In some embodiments, intake aperture 312 and exit aperture 314 may be positioned at the same side of brewing device 300, or on the opposite sides as shown in FIG. 3C. In some embodiments, the pumping of water into and out of the pipe structure may create currents in water 370 that may allow heat and/or the steeped brewing agent to be distributed evenly.

In some embodiments, brew chamber 316 is configured to house a brewing agent 320. In some embodiments brew chamber 316 may be brew chamber 218 and the brewing agent 320 may be brewing agent 220. FIG. 3B depicts a brew chamber 316 in an opened position, allowing a brewing agent 320 to be loaded and unloaded. In some embodiments, the brewing agent 320 may be loose-leaf tea leaves. In other embodiments, the brewing agent 320 may be tea leaves contained within a tea bag. In other embodiments, the brewing agent 320 may be ground coffee beans. In some embodiments, such coffee beans may be contained within a perforated bag. In other embodiments, the brewing agent 320 may be contained in any other suitable container that would allow water to contact and steep the brewing agent 320. In some embodiments, brew chamber 316 may comprise a box structure with a solid outer face that produces a water tight seal when closed into brewing device 300, as shown in FIG. 3A. In some embodiments, the one or more walls of brew may comprise a grated structure or other perforated filtering structure that keeps the brewing agent 320 within brew chamber 316, while allowing water 370 to pass between brew chamber 316 and the pipe structure. In some embodiments, brew chamber 316 may include an upper structure to tamp, compact, or secure the brewing agent 320 in place within brew chamber 316. FIG. 3C depicts a brewing device 300 with an alternate brew chamber 316-A. In some embodiments, brew chamber 316-A may be a detachable container structure which may be detached to load and unload brewing agent 320.

In some embodiments, water 370 in the pipe structure may be pumped directly into brew chamber 316. In some embodiments, water 370 may pass from the pipe structure, into chamber 316, and directly back out to the container through an exit aperture 314 of the pipe structure. In some embodiments, brewing device 300 may additionally, or alternatively, include an exit aperture 314-A allowing water pumped through device 360 to exit through brew chamber 316. In other embodiments, however, water 370 pumped through device 300 may not access brew chamber 316 before water 370 is heated to a predetermined temperature. As previously described, in some embodiments, the pipe structure and brew chamber 316 may be separated by a water tight divider such that the water 370 pumped through the pipe structure may not enter the brew chamber 316 until such divider is moved and/or shifted. In such embodiments, the divider may remain in place as the water 370 is heated by a heating element and pumped water 370 may directly exit through exit aperture 314 without entering brew chamber 316.

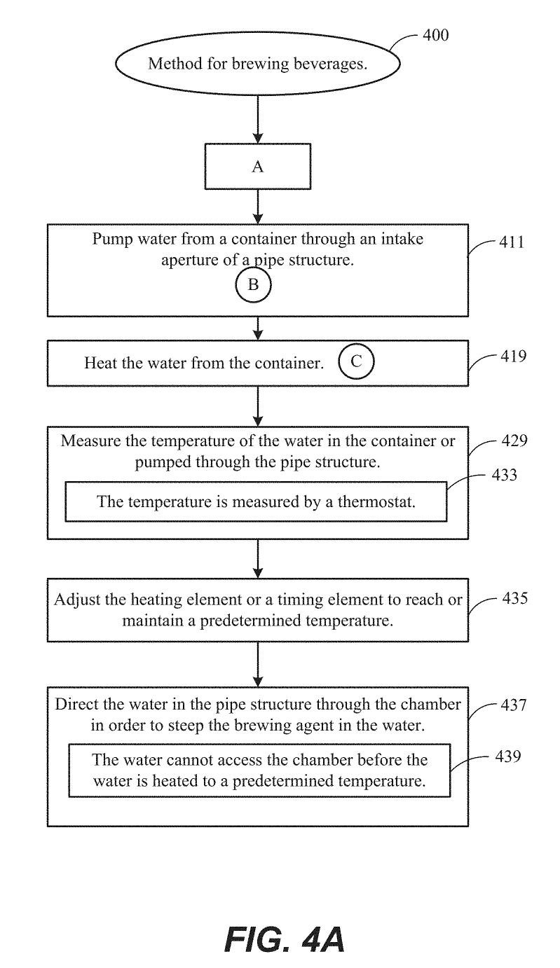

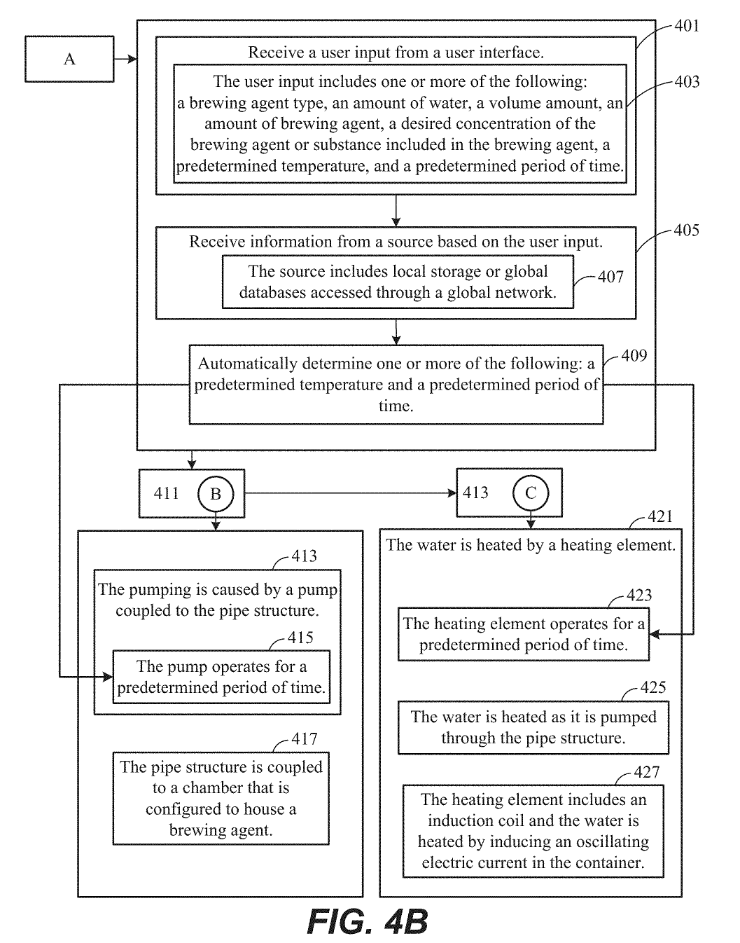

FIG. 4A and FIG. 4B illustrate an example of a technique 400 for brewing beverages, in accordance with one or more embodiments. At step 401, in FIG. 4B, user input 403 is received from a user interface. In some embodiments, the user interface may be user interface 202, as described in FIG. 2. In various embodiments, user input 403 includes one or more of the following: a brewing agent type, an amount of water, a volume amount, an amount of brewing agent, a desired concentration of the brewing agent or substance included in the brewing agent, a predetermined temperature, and a predetermined period of time. As further described in FIG. 2, in some embodiments, the user interface may communicate such inputs to a programmable system controller, such as programmable system controller 204, which may control various elements of a brewing device, such as brewing device 250.

At 405, information is received from a source 407 based on the user input 403. In various embodiments, source 407 may include local storage on a brewing device, such as brewing device 250. In other embodiments, source 407 may include global databases accessed through a global network. As previously described in FIG. 2, a system controller, such as programmable system controller 204 may receive information from a source 407 based on user input 403. In various embodiments, information received from a source may include information relevant to the user input 403, such as recommended temperatures to steep various brewing agents. In other embodiments, information received may include recommended times to steep various brewing agents. In some embodiments, receiving such relevant information may include searching local storage and/or global databases using the user input 403. In some embodiments, received information may be ranked based on use by previous users or based on relevance determined through keyword searches or aggregated user network information, e.g. online ratings and reviews, social media, search history, etc.

At 409, a predetermined temperature, a predetermined period of time, or both is automatically determined. In some embodiments, a predetermined temperature to steep the brewing agent is determined based on the relevant information received at step 405. In some embodiments, a predetermined period of time to steep the brewing agent is determined based on the relevant information received at step 405. In some embodiments, the predetermined temperature and/or predetermined period of time may be input by a user at the user interface. In some embodiments, determining a predetermined temperature and/or a predetermined period of time to steep the brewing agent may include selecting the top ranked result. In other embodiments, determining a predetermined temperature and/or a predetermined period of time to steep the brewing agent may include averaging the recommended temperatures and/or times from a number of the most relevant results. In other embodiments, determining a predetermined temperature and/or a predetermined period of time to steep the brewing agent may include presenting the user with the information received at step 405 and prompting the user to select a desired temperature and/or time.

At step 411, water from a container is pumped through an intake aperture of a pipe structure. In some embodiments, the container may be container 260 and the pipe structure may be pipe structure 214. In some embodiments, the water may enter the pipe structure through an intake aperture and may exit through an exit aperture back into the container. In some embodiments, the pipe structure may be coupled to a chamber 417 that is configured to house a brewing agent. In some embodiments, chamber 417 may be brew chamber 218 and the brewing agent may be brewing agent 220. According to various embodiments, the pumping is caused by a pump 413 coupled to the pipe structure. In some embodiments pump 413 may be pump 206. In some embodiments, pump 413 may operate (415) for the predetermined period of time, as may be determined in step 409. In some embodiments, the operation of pump 413 may be controlled by a system controller, such as programmable system controller 204.

At step 413, water from the container is heated. In some embodiments, the water may be water 270. In some embodiments, the water may be heated by a heating element 421. In some embodiments, heating element 421 may be heating element 210. In some embodiments, heating element 421 may operate (423) for the predetermined period of time, as may be determined in step 409. In some embodiments, the water is heated (425) as it is pumped through the pipe structure. Alternatively or additionally, the heating element 421 may include an induction coil and the water may be heated (427) by inducing an oscillating electric current in the container.

At 429, the temperature of the water, in the container or pumped through the pipe structure, is measured. In some embodiments, the temperature is measured by a thermostat 433. In some embodiments, thermostat 433 may be thermostat 216. In some embodiments, the temperature may be measured from the water in the container. In other embodiments, the temperature may be measured form the water being pumped through the pipe structure. In some embodiments, the thermostat 433 may be set with the predetermined temperature determined. In some embodiments, a system controller, such as programmable system controller may set the thermostat 433 with the predetermined temperature determined at step 409 or a predetermined temperature received as user input 403 at step 401.

At step 435 the heating element 421 or a timing element, such as timing element 208, may be adjusted to reach or maintain a predetermined temperature. In some embodiments the predetermined temperature may be the predetermined temperature determined at step 409 or a predetermined temperature received as input 409 at step 401. In some embodiments, heating element 421 may be adjusted by modification in energy output. In other embodiments, heating element 421 may be adjusted by shutting heating element 421 off as soon as the temperature of the water rises a predetermined increment above the predetermined temperature, and turning heating element 421 on as soon as the temperature drops a predetermined increment below the predetermined temperature. In some embodiments, heating element 421 may be directly adjusted by thermostat 433. In other embodiments, heating element 421 may be adjusted by a system controller, such as programmable system controller 204.

At step 437, the water in the pipe structure is directed through the chamber 417 in order to steep the brewing agent in the water. In some embodiments, the chamber 417 and the pipe structure may be separated by a grate or other perforated filtering structure that keeps the brewing agent within chamber 417, while allowing water to pass between chamber 417 and the pipe structure. In some embodiments, water may pass from the pipe structure, into chamber 417, and directly back out to the container through an exit aperture in chamber 417. In other embodiments, chamber 417 may not have an exit aperture. In such embodiments, the water may pass back into the pipe structure as the brewing agent is steeped, and pass into the container through an exit aperture of the pipe structure.

As previously described, in some embodiments, the water may be pumped through the pipe structure and directly into chamber 417. This would allow the water to begin to steep the brewing agent before being heated. However, in some embodiments, the water cannot access (439) the chamber 417 before the water is heated to a predetermined temperature. As previously described, in some embodiments, the pipe structure and chamber 417 may be separated by a water tight divider such that the water pumped through the pipe structure may not enter the chamber 417 until such divider is moved and/or shifted. In such embodiments, the divider may remain in place as the water is heated by heating element 421. When thermostat 433 detects that the water has been heated to a predetermined temperature, thermostat 433 may signal a system controller to move the divider to allow heated water to enter the chamber 417 to being steeping the brewing agent. In some embodiments, thermostat 433 may directly control the divider. This would allow the brewing agent to be steeped by water at a specific predetermined temperature for a predetermined period of time.

FIG. 5 is a block diagram illustrating an example of a system 500 capable of implementing various processes described in the present disclosure. In some embodiments, system 500 may be a client device, such as client device 102 or brewing device 250. In some embodiments, system 500 may represent programmable system controller 204. According to particular embodiments, a system 500, suitable for implementing particular embodiments of the present disclosure, includes a processor 501, a memory 503, an interface 511, and a bus 515 (e.g., a PCI bus or other interconnection fabric) and operates as a streaming server. In some embodiments, when acting under the control of appropriate software or firmware, the processor 501 is responsible for processing inputs received from a user interface, such as in step 401. In other embodiments, the processor 401 is responsible for receiving relevant information from one or more databases and determining a predetermined temperature or period of time, as in step 409. Various specially configured devices can also be used in place of a processor 501 or in addition to processor 501. In other embodiments, system 500 may also include one or more of the following elements: a pump, a timing element, a heating element, a thermostat, and a concentration detector.

The interface 511 is typically configured to send and receive data packets or data segments over a network, such as network 104. Interface 511 may also be configured to communicate with and control various device elements and components, such as the elements and components of brewing device 250, as described in FIG. 2. Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 500 uses memory 503 to store data and program instructions for operations including receiving user input, such as in step 401, receiving information from various sources, such as in step 405, automatically determining a predetermined temperature and/or period of time, such as in step 409, and/or controlling various device elements and components. The program instructions may control the operation of an operating system and/or one or more applications, for example. The memory or memories may also be configured to store received metadata and batch requested metadata.

Because such information and program instructions may be employed to implement the systems/techniques described herein, the present disclosure relates to tangible, or non-transitory, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

While the present disclosure has been particularly shown and described with reference to specific embodiments thereof, it will be understood by those skilled in the art that changes in the form and details of the disclosed embodiments may be made without departing from the spirit or scope of the present disclosure. It is therefore intended that the present disclosure be interpreted to include all variations and equivalents that fall within the true spirit and scope of the present disclosure. Although many of the components and processes are described above in the singular for convenience, it will be appreciated by one of skill in the art that multiple components and repeated processes can also be used to practice the techniques of the present disclosure.

What is claimed is:

1. A device for brewing beverages, the device comprising:
a pipe structure coupled to a chamber, the chamber being configured to house a brewing agent;
a pump coupled to the pipe structure, the pump being configured to cause water in a container to be pumped through an intake aperture in the pipe structure; and
a heating element coupled to the pipe structure, wherein the heating element causes the water to be heated; and
wherein, water in the pipe structure is directed through the chamber in order to steep the brewing agent in the water.

2. The device of claim 1, wherein the water is heated as it is pumped through the pipe structure.

3. The device of claim 1,
wherein the heating element includes an induction coil; and
wherein the water is heated by inducing an oscillating electric current in the container.

4. The device of claim 1, further comprising a thermostat, wherein the thermostat measures the temperature of the water in the container, or pumped through the pipe structure, and causes the device to adjust the heating element or a timing element to reach or maintain a predetermined temperature.

5. The device of claim 1, wherein the water cannot access the chamber before the water is heated to a predetermined temperature.

6. The device of claim 1, wherein the pump or the heating element operates for a predetermined period of time.

7. The device of claim 1, further comprising a concentration detector;
wherein the concentration detector measures the concentration of the brewing agent, or a substance included in the brewing agent, in the water; and
wherein the water cannot access the chamber once a desired concentration of the brewing agent, or substance included in the brewing agent, has been detected in the water.

8. The device of claim 1, further comprising a user interface to receive user input, the user input including one or more of the following:
a brewing agent type;
an amount of water;
a volume amount;
an amount of brewing agent;
a desired concentration of the brewing agent, or substance included in the brewing agent;
a predetermined temperature; and
a predetermined period of time.

9. The device of claim 8, wherein the device is configured to:
receive user input from the user interface;
receive information from a source based on the user input; and
automatically determine one or more of the following:
the predetermined temperature; and
the predetermined time.

10. The device of claim 9, wherein the source includes local storage or global databases accessed through a global network.

11. A method for brewing beverages, the method comprising:
pumping water from a container through an intake aperture of a pipe structure;
wherein the pumping is caused by a pump coupled to the pipe structure;
wherein the pipe structure is coupled to a chamber, the chamber being configured to house a brewing agent;
heating the water from the container;
wherein the water is heated by a heating element; and
directing the water in the pipe structure through the chamber in order to steep the brewing agent in the water.

12. The method of claim 11, wherein the water is heated as it is pumped through the pipe structure.

13. The method of claim 11,
wherein the heating element includes an induction coil; and
wherein the water is heated by inducing an oscillating electric current in the container.

14. The method of claim 11, further comprising:
measuring the temperature of the water in the container or pumped through the pipe structure, wherein the temperature is measured by a thermostat; and
adjusting the heating element or a timing element to reach or maintain a predetermined temperature;

15. The method of claim 11, wherein the water cannot access the chamber before the water is heated to a predetermined temperature.

16. The method of claim 11, wherein the pump or the heating element operates for a predetermined period of time.

17. The method of claim 11, further comprising:
receiving a user input from a user interface;
receiving information from a source based on the user input; and
automatically determining one or more of the following:
a predetermined temperature; and
a predetermined period of time.

18. The method of claim 17, wherein the user input includes one or more of the following:
a brewing agent type;
an amount of water;
a volume amount;
an amount of brewing agent;
a desired concentration of the brewing agent, or substance included in the brewing agent;
the predetermined temperature; and
the predetermined period of time.

19. The method of claim 17, wherein the source includes local storage or global databases accessed through a global network.

20. A system for brewing beverages, the system comprising:
one or more processors;
memory;
a pipe structure coupled to a chamber, the chamber being configured to house a brewing agent;
a pump coupled to the pipe structure, the pump being configured to cause water in a container to be pumped through an intake aperture in the pipe structure; and
a heating element coupled to the pipe structure, wherein the heating element causes water in the container to be heated;
wherein, the water in the pipe structure is pumped through the chamber in order to steep the brewing agent in the water.
